(19) United States
(12) Patent Application Publication
(10) Pub. No.: US 2025/0099906 A1
(43) Pub. Date: Mar. 27, 2025

(54) INTEGRATED MULTISTAGE HEAT EXCHANGER AND LIQUID DESICCANT REGENERATOR AND ASSOCIATED METHOD

(71) Applicant: Alliance for Sustainable Energy, LLC, Golden, CO (US)

(72) Inventor: Eric KOZUBAL, Superior, CO (US)

(21) Appl. No.: 18/890,948

(22) Filed: Sep. 20, 2024

Related U.S. Application Data
(60) Provisional application No. 63/584,433, filed on Sep. 21, 2023.

(51) Int. Cl. B01D 53/14; B01D 53/26

(52) U.S. Cl. CPC B01D 53/1425; B01D 53/263; B01D 2257/80; B01D 2258/06

(57) ABSTRACT

A regeneration system including a liquid desiccant regeneration loop comprising a liquid desiccant tank and a heat and mass exchanger; and a heating loop comprising a first heating zone and a second heating zone, where temperatures in the first heating zone are higher than temperatures in the second heating zone. The low concentration liquid desiccant in the liquid desiccant tank flows sequentially from the second heating zone to the first heating zone then through the heat and mass exchanger before being stored as high concentration liquid desiccant, and a portion of the low concentration liquid desiccant exiting the first heating zone or the second heating zone is used as a heating fluid for the heat and mass exchanger. A method of operating such a regeneration system is also provided.

### CROSS-REFERENCE TO RELATED APPLICATION

This application claims the benefit of priority to U.S. Provisional Patent Application No. 63/584,433, filed on Sep. 21, 2023, the entire disclosure of which is expressly incorporated herein by reference to its entirety.

### CONTRACTUAL ORIGIN

This invention was made with government support under Contract No. DE-AC36-08GO28308 awarded by the Department of Energy. The government has certain rights in this invention.

### TECHNICAL FIELD

The disclosure relates generally to heat and mass exchange systems, such as those that can be used to regenerate liquid desiccant.

### BACKGROUND

Heat and mass exchangers are known to be useful as liquid desiccant regenerators. The heat and mass exchanger both heats the liquid desiccant and provides an air stream that removes water vapor to convert low concentration liquid desiccant into high concentration liquid desiccant.

### SUMMARY

In some embodiments, a regeneration system is provided. The regeneration system can include a liquid desiccant regeneration loop comprising a liquid desiccant tank, a second heating zone, a first heating zone, and a heat and mass exchanger; and a heating loop comprises the first heating zone and the second heating zone. In the regeneration system, the temperatures in the first heating zone are higher than temperatures in the second heating zone; low concentration liquid desiccant in the liquid desiccant tank flows sequentially from the second heating zone to the first heating zone then through the heat and mass exchanger before being stored as high concentration liquid desiccant; and a portion of the low concentration liquid desiccant exiting the first heating zone or the second heating zone is used as a heating fluid for the heat and mass exchanger.

In some embodiments, the regeneration system also includes a third heating zone. In some embodiments, the liquid desiccant regeneration loop and the heating loop each comprise the third heating zone, wherein temperatures in the first heating zone are higher than temperatures in the second heating zone, and temperatures in the second heating zone are higher than temperatures in the third heating zone. In some embodiments, low concentration liquid desiccant in the liquid desiccant tank flows sequentially from the third heating zone to the second heating zone to the first heating zone then through the heat and mass exchanger before returning to the liquid desiccant tank as high concentration liquid desiccant. In some such embodiments, a portion of the low concentration liquid desiccant exiting the second heating zone is used as a first heating fluid for the heat and mass exchanger, and wherein a portion of the low concentration liquid desiccant exiting the third heating zone is used as a second heating fluid for the heat and mass exchanger.

In another aspect, a regeneration system capable of operating in evaporator coil anti-frost mode is provided that includes a liquid desiccant regeneration loop comprising a liquid desiccant tank, a heating zone, and a heat and mass exchanger; and a refrigerant loop comprising the heating zone, an expansion valve, an evaporator, and a compressor. In these regeneration systems, a first portion of liquid desiccant in the liquid desiccant tank flows into the heat and mass exchanger and is then returned to the liquid desiccant tank; regeneration air is passed through the heat and mass exchanger, wherein the first portion of liquid desiccant flowing in the heat and mass exchanger dehumidifies the regeneration air to form a dehumidified exhaust stream, and the dehumidified exhaust stream is fed to the evaporator in order to reduce the presence of frost on an evaporator coil of the evaporator.

In another aspect, a method of operating a regeneration system is provided that includes heating low concentration liquid desiccant; and flowing a first portion of the heated low concentration liquid desiccant through a heat and mass exchanger to produce high concentration liquid desiccant, and where a second portion of heated low concentration liquid desiccant is used to drive moisture from a first portion of the low concentration liquid desiccant within the heat and mass exchanger.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates a regeneration system containing a first and second heating zone as described herein;

FIG. 2 illustrates a second regeneration system containing a first and second heating zone as described herein;

FIG. 3 illustrates a third regeneration system containing a first and second heating zone as described herein;

FIG. 4 illustrates a regeneration system containing a first, second, and third heating zone as described herein;

FIG. 5 illustrates a second regeneration system containing a first, second, and third heating zone with two liquid desiccant regeneration tanks as described herein;

FIG. 6 illustrates a third regeneration system containing a first, second, and third heating zone with a distribution feed tube as described herein;

FIG. 7 illustrates a fourth regeneration system containing a first, second, and third heating zone with a distribution feed tube connected to a unit operation requiring a heat sink as described herein;

FIG. 8 illustrates a regeneration system containing a first, second, and third heating zone as described herein operating in heating mode;

FIG. 9 illustrates a regeneration system containing a first, second, and third heating zone as described herein operating in evaporator coil anti-frost mode;

FIG. 10 is a graph showing the fluid temperature versus enthalpy for the liquid desiccant and refrigerant as they flow through the first, second, and third heating zones as described herein;

FIG. 11 illustrates heat exchanger including first, second, and third heating zones as described herein; and

FIG. 12 illustrates a simplified regeneration system capable of operating in evaporator coil anti-frost mode according to some embodiments described herein.

FIG. 13 illustrates a regeneration system using a regeneration heat and mass exchanger, an integrated shell and tube heat exchanger, stratification tube, and cold climate heat pump operation according to some embodiments described herein.

FIG. 14 illustrates a regeneration system using a regeneration heat and mass exchanger, an integrated shell and tube heat exchanger, and cold climate heat pump operation according to some embodiments described herein.

FIG. 15 illustrates a regeneration system using refrigerant to air subcooling, a regeneration heat and mass exchanger, integrated shell and tube heat exchanger, and cold climate heat pump operation according to some embodiments described herein.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

As shown in the figures, embodiments of the present disclosure relate generally to a regeneration system 10 that includes a liquid desiccant regeneration loop 12 including a liquid desiccant (LD) tank 14, a second heating zone 22, a first heating zone 20, and a heat and mass exchanger (HMX) 16; and a heating loop 18 comprising a first heating zone 20 and a second heating zone 22, wherein temperatures in the first heating zone 20 are higher than temperatures in the second heating zone 22. Low concentration liquid desiccant in the liquid desiccant tank 14 flows sequentially from the second heating zone 22 to the first heating zone 20, then through the heat and mass exchanger 16 before being stored as high concentration liquid desiccant in the LD tank 14. In addition, a portion of the low concentration liquid desiccant exiting the first heating zone 20 or the second heating zone 22 is used as a heating fluid for the heat and mass exchanger 16. In some embodiments, after the portion of the low concentration liquid desiccant is used as a heating fluid, the low concentration liquid desiccant is returned to one of the heating zones 20, 22.

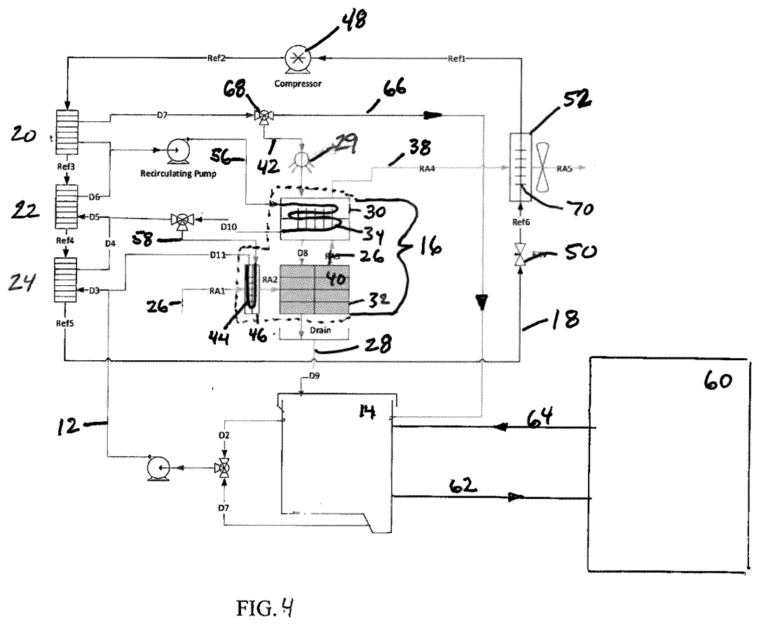

In some embodiments, as shown in FIG. 4, the high concentration liquid desiccant and the low concentration liquid desiccant are stored in two different LD tanks (a high concentration tank 14A and a low concentration tank 14B).

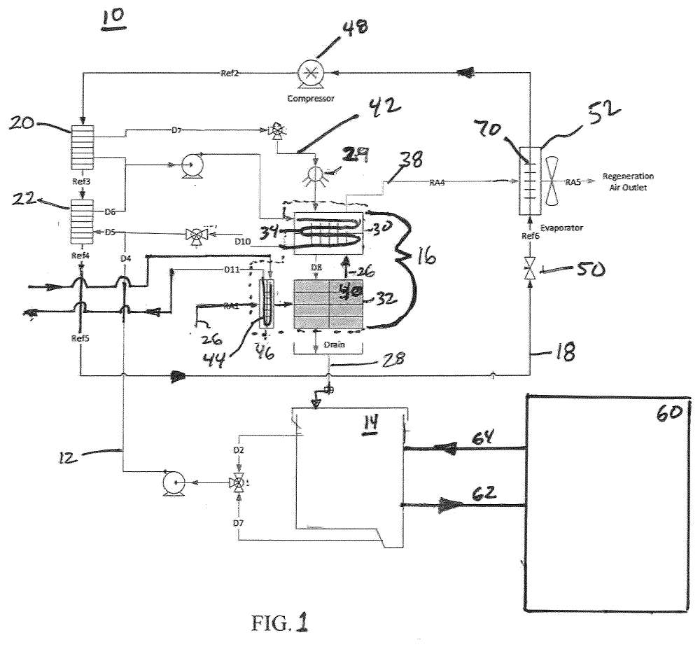

In some embodiments, as shown in FIGS. 1-3 and 5-8, the high concentration liquid desiccant and the low concentration liquid desiccant are stored in the same tank 14. In such tanks, the tank is stratified with the high concentration liquid desiccant accumulating toward the bottom of the tank, and the low concentration liquid desiccant accumulating toward the top of the tank. The term LD tank 14 encompasses both dual tanks 14A/14B and a single stratified tank 14.

The heat and mass exchanger 16 includes an HMX core 30 and can also include an evaporative media stage 32, a regeneration air heater 46, or both.

As shown in the figures, the HMX core 30 contacts regeneration air 26 with heated low concentration liquid desiccant exiting the first heating zone 20. The HMX core 30 contains a plurality of HMX heat transfer tubes 34, which are adapted to contain a heating fluid (e.g., low concentration liquid desiccant from one of the first, second, or third heating zones 20, 22, 24) on the inside and heat the low concentration liquid desiccant flowing within the HMX core 30 but outside the HMX heat transfer tubes 34 (e.g., the low concentration liquid desiccant forming the LCLD feed stream 42 that is fed through the distributor 29). The heat inside the HMX core 30 drives moisture from the low concentration liquid desiccant into the regeneration air stream 26 to form an exhaust stream 38 exiting the HMX core 30 and a high concentration liquid desiccant stream 28.

When present, the evaporative media stage 32 includes evaporative media 40, such as CELdek (sold by Cooling Media). In some embodiments, the liquid desiccant exiting the HMX core 30 passes through the evaporative media 40 and is contacted with the regeneration air stream 26. The liquid desiccant is collected and exits the evaporative media stage 32 as high concentration liquid desiccant 28, which is returned to the liquid desiccant tank 14 or 14A.

When present, the regeneration heater 46 is adapted for heating regeneration air 26 before it is fed into the evaporative media stage 32 or the HMX core 30.

In some embodiments, as shown in FIGS. 1-9, a low concentration liquid desiccant (LCLD) feed stream 42 that has exited the first heating zone 20 is fed into the heat and mass exchanger 16 and is contacted with a regeneration air stream 26 and heated by the HMX heat transfer tubes 34. In some embodiments, the liquid desiccant exits the heat and mass exchanger 16 as a high concentration liquid desiccant stream 28. In some embodiments, a distributor 29 feeds the LCLD feed stream 42 into the HMX core 30. In some embodiments, the distributor 29 can be one or more sprayers or drip tubes.

In some embodiments, a portion of the low concentration liquid desiccant exiting the first or second heating zone flows within the HMX heat transfer tubes 34 in the heat and mass exchanger 16. In some such embodiments, the HMX heat transfer tubes 34 are adapted to heat the LCLD feed stream 42 being regenerated within the heat and mass exchanger 16.

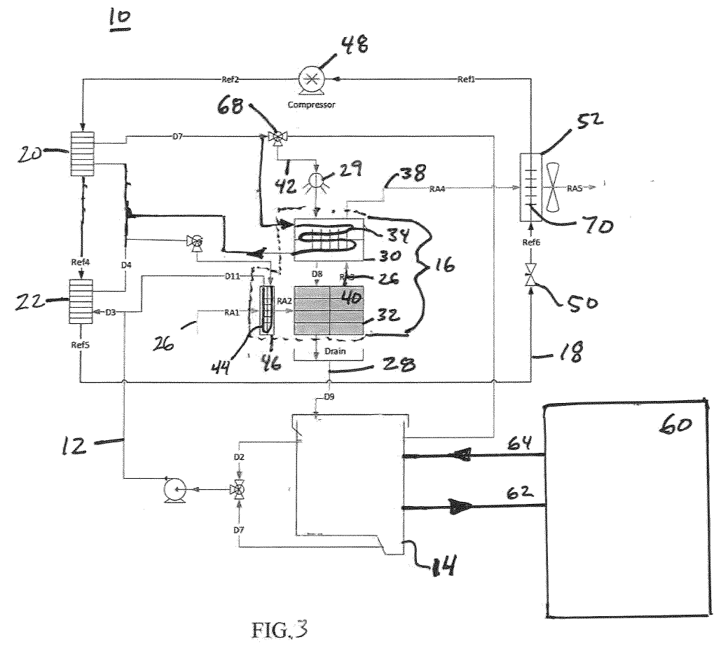

In some embodiments, as shown in FIG. 3, the portion of the low concentration liquid desiccant exiting the first heating zone 20 flows within HMX heat transfer tubes 34 in the heat and mass exchanger 16. In some such embodiments, the portion of the low concentration liquid desiccant exiting the HMX heat transfer tubes 34 is returned to the first heating zone 20.

In some embodiments, as shown in FIG. 1, the portion of the low concentration liquid desiccant exiting the second heating zone 22 flows within HMX heat transfer tubes 34 in the heat and mass exchanger 16. In some such embodiments, the portion of the low concentration liquid desiccant exiting the HMX heat transfer tubes 34 is returned to the second heating zone 22.

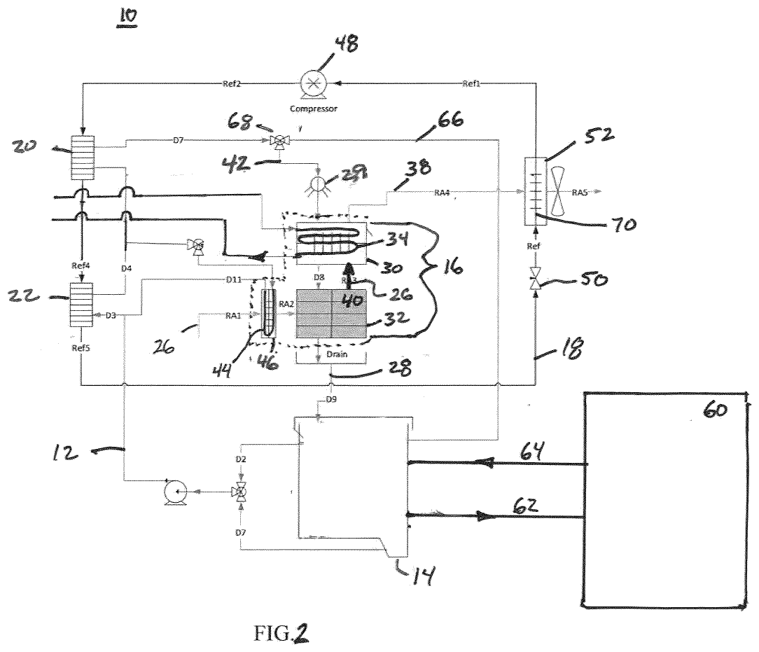

In some embodiments, as shown in FIGS. 2 and 3, a portion of low concentration liquid desiccant exiting the second heating zone 22 flows within regeneration air heating tubes 44 (e.g. a finned heating coil) to heat the regeneration air stream 26 before it is fed to the HMX core 30 or evaporative media stage 32. The regeneration air heater 46 can be a heat exchanger where the regeneration air stream 26 flows on the outside of the regeneration air heating tubes 44. In some such embodiments, the low concentration liquid desiccant exiting the regeneration air heating tubes 44 is returned to the second heating zone 22.

In some such embodiments, once the heated regeneration air stream 26 exits the regeneration air heater 46 it flows into the HMX core 30 and/or evaporative media stage 32, contacts the LCLD feed stream 42 within the heat and mass exchanger 16, and exits as exhaust air 38. In some embodiments, the heated regeneration air 26 contacts the LCLD feed stream 42 in the HMX core 30. In some embodiments, the heated regeneration air 26 contacts the LCLD feed stream 42 in the evaporative media stage 32.

In some embodiments of FIG. 3, a portion of the low concentration liquid desiccant exiting the first heating zone 20 flows within HMX heat transfer tubes 34 in the HMX core 30, and the HMX heat transfer tubes 34 are adapted to heat low concentration liquid desiccant being regenerated within the HMX core 30. In such embodiments, the low concentration liquid desiccant exiting the HMX heat transfer tubes 34 is returned to the first heating zone 20.

In some embodiments, the first heating zone 20 and the second heating zone 22 are part of the same heat exchanger. In some embodiments, the first heating zone 20 and the second heating zone 22 are part of different heat exchangers.

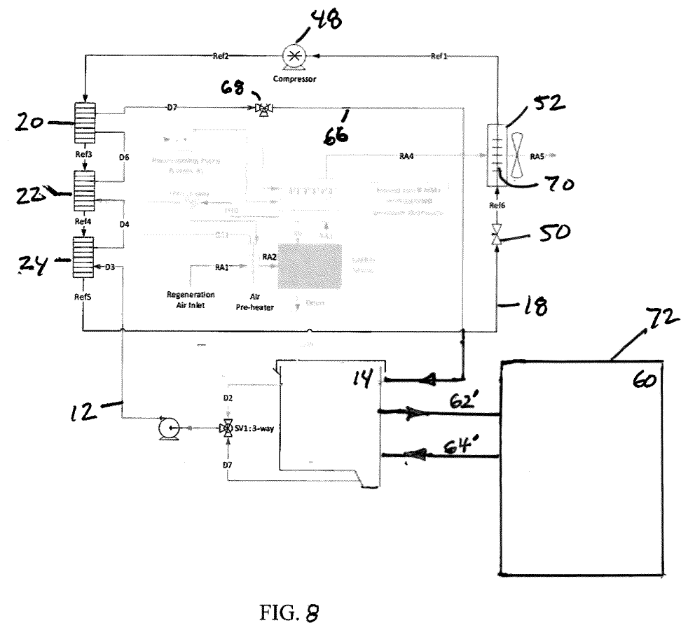

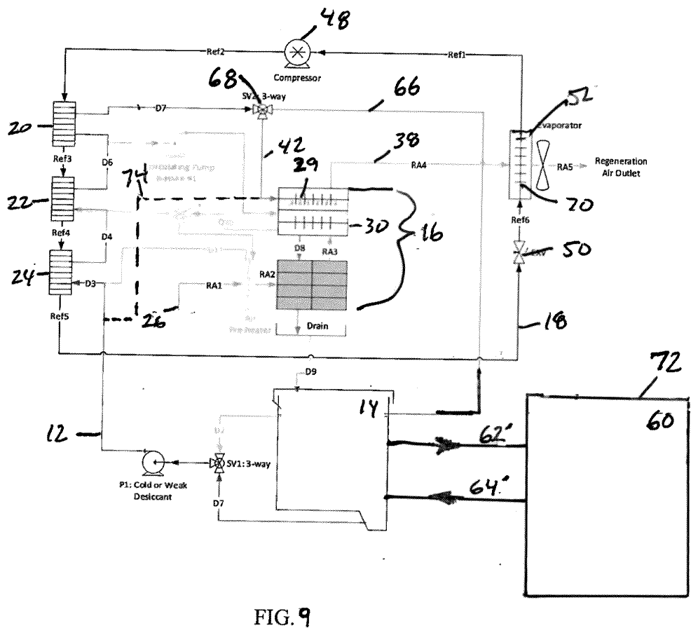

In some embodiments, as shown in FIGS. 4-9, the regeneration system 10 includes a third heating zone 24. FIGS. 4-7 show the regeneration system 10 operating in regeneration mode, while FIGS. 8 and 9, show the regeneration system 10 operating in heating mode and evaporator coil anti-frost mode, respectively.

In some embodiments, the heating loop 18 includes the third heating zone 24, where temperatures in the first heating zone 20 are higher than temperatures in the second heating zone 22, and temperatures in the second heating zone 22 are higher than temperatures in the third heating zone 24. In some such embodiments, low concentration liquid desiccant in the liquid desiccant tank 14/14B flows sequentially to the third heating zone 24 then to the second heating zone 22 to the first heating zone 20 then through the heat and mass exchanger 16 before returning to the liquid desiccant tank 14/14A as a high concentration liquid desiccant stream 28. In some embodiments, a portion of the low concentration liquid desiccant exiting the second heating zone 22 is used as a first heating fluid 56 for the heat and mass exchanger 16 (e.g., the HMX core 30), and a portion of the low concentration liquid desiccant exiting the third heating zone 24 is used as a second heating fluid 58 for the heat and mass exchanger 16 (e.g., the regeneration air heater 46).

In some embodiments, low concentration liquid desiccant exiting the first heating zone 20 is used as a LCLD feed stream 42 that is fed into the heat and mass exchanger 16 and contacted with a regeneration air stream 26, then exits the heat and mass exchanger 16 as a high concentration liquid desiccant stream 28. In particular, the LCLD feed stream 42 is fed into the heat and mass exchanger 16 via a distributor 29. The LCLD feed stream 42 can be fed into the HMX core 30. In some embodiments, the distributor 29 can be one or more sprayers or drip tubes.

In some embodiments, the first heating fluid 56 flows within HMX heat transfer tubes 34 in the HMX core 30, and the HMX heat transfer tubes 34 are adapted to heat low concentration liquid desiccant being regenerated within the HMX core. In particular, the first heating fluid 56 flows inside the HMX heat transfer tubes 34, while the LCLD feed stream 42 flows outside the HMX heat transfer tubes 34 and contacts the regeneration air stream 26. In some embodiments, the first heating fluid 56 is then returned to the second heating zone 22.

In some embodiments, the second heating fluid 58 flows within regeneration air heating tubes 44 to heat regeneration air 26 fed to the heat and mass exchanger 16. The heated regeneration air 26 then flows within the heat and mass exchanger 16 and contacts low concentration liquid desiccant within the heat and mass exchanger 16 before exiting the HMX core 30 as exhaust air 38. In particular, the heated regeneration air 26 contacts the low concentration liquid desiccant within the HMX core 30 and, if present, the evaporative media stage 32. In some embodiments, the second heating fluid 58 is then returned to the third heating zone 24.

In some embodiments, the first heating fluid 56 exits the second heating zone 22 then flows through the HMX heat transfer tubes 34, then serves as the second heating fluid 58 and flows through the regeneration air heating tubes 44 before being returned to the third heating zone 24. In such embodiments, the second heating fluid 58 is not obtained from the third heating zone 24. In some such embodiments, a portion of the first heating fluid 56 can be returned to the second heating zone 22, while another portion of the first heating fluid 56 can serve as the second heating fluid 58 before being returned to the third heating zone 24.

In the regeneration air heater 46, the regeneration air 26 flows outside of regeneration air heating tubes 44. Then, in the evaporator media stage 32 and the heat and mass exchanger 16, water vapor from the low concentration liquid desiccant is received by the regeneration air 26 to form the exhaust stream 42.

In some embodiments, after being used as a heating fluid, the first heating fluid 56 and the second heating fluid 58 are independently returned to one of the first, second, or third heating zones 20, 22, 24. In some embodiments, as shown in FIGS. 4-7, the first heating fluid 56 is returned to the second heating zone 22, and the second heating fluid 58 is returned to the third heating zone 24.

The regeneration systems 10 described herein can be coupled to a dehumidification system 60 that consumes the liquid desiccant. The dehumidification can be part of an air conditioning system (e.g., the conditioner of an LD air conditioning system) or any other operation adapted to consume high concentration liquid desiccant to dehumidify a gas stream.

The liquid desiccant tank(s) 14 can be coupled to the dehumidification system 60. In particular, high concentration liquid desiccant 62 can be fed to the dehumidification system 60, which returns low concentration liquid desiccant 64.

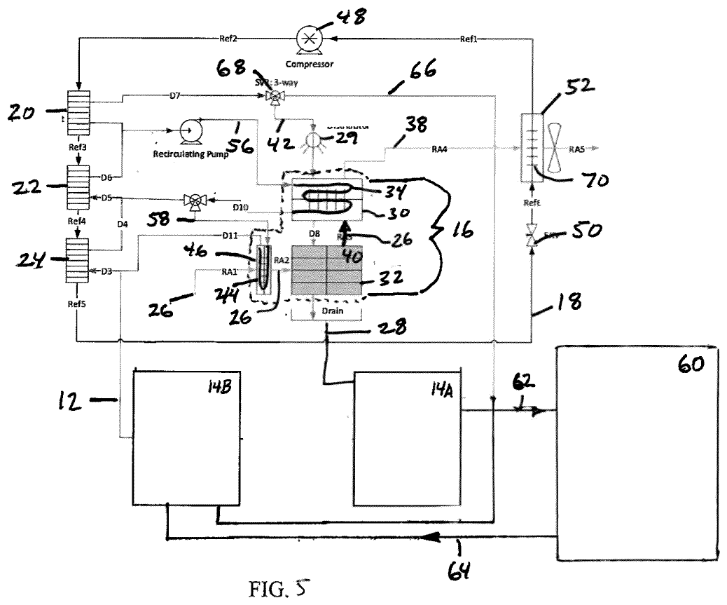

In some embodiments, as shown in FIG. 5, the high concentration liquid desiccant 62 can be sourced from a high concentration tank 14A, while the low concentration desiccant 64 is returned to the low concentration tank 14B.

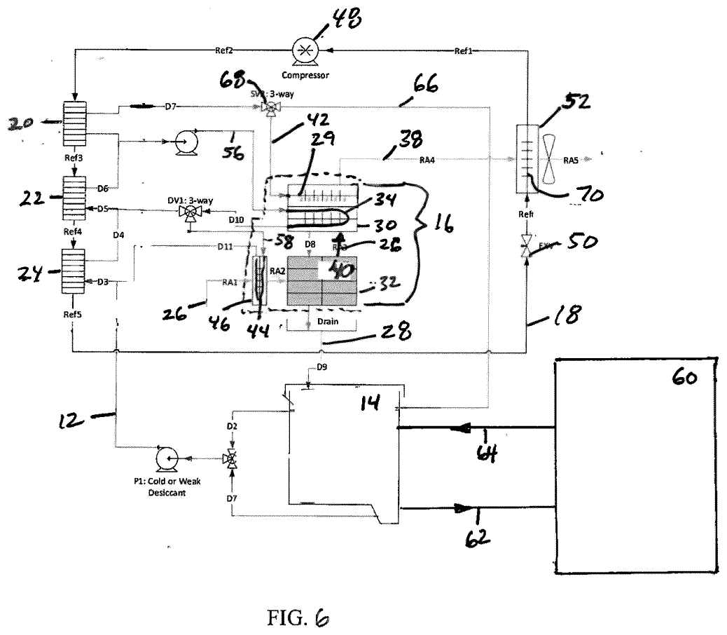

In some embodiments, as shown in FIG. 6, the high concentration liquid desiccant 62 can be sourced from the bottom of the liquid desiccant tank 14, while the low concentration desiccant 64 is returned to the top of the liquid desiccant tank 14. In such embodiments, the tank 14 is a stratified tank where the high concentration liquid desiccant 62 sinks to the bottom of the tank 14 and the low concentration liquid desiccant 64 remains at the top of the tank 14.

In some embodiments, as shown in FIG. 6, the distributor 29 can be one or more drip tubes. The drip tubes can be similar to the HMX heat transfer tubes 34 except that they include openings to feed the LCLD feed stream 42 into the HMX core 30. In some embodiments, the distributor 29 is positioned above the HMX heat transfer tubes 34.

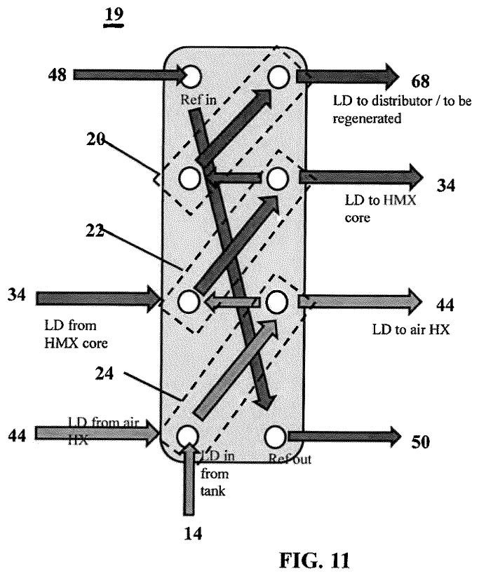

In some embodiments, the first heating zone 20, the second heating zone 22, and the third heating zone 24 are part of the same heat exchanger. For instance, the first, second, and third heating zones 20, 22, 24 can be part of a large heat exchanger where the first and second heating fluids 56, 58 can be sourced from feed lines at different levels and temperatures along the length of the heat exchanger (e.g., the first heating fluid is sourced upstream of the second heating fluid). As example of such a heat exchanger is shown in FIG. 11, which can serve as heating zones 20, 22, and 24 in FIGS. 4-9. As can be seen, liquid desiccant from the liquid desiccant tank 14 can enter the unitary heat exchanger 19, which will heat the liquid desiccant in the third heating zone 24. A portion of the liquid desiccant reaching the extent of the third heating zone 24 can be provided to the regeneration air heating tubes 44 before being returned to the beginning of the third heating zone 24. Another portion of the liquid desiccant reaching the extent of the first heating zone 24 will proceed to the second heating zone 22 (horizontal arrow).

A portion of the liquid desiccant reaching the extent of the second heating zone 22 can be provided to the HMX heat transfer tubes 34 before being returned to the beginning of the second heating zone 22. Another portion of the liquid desiccant reaching the extent of the second heating zone 22 will proceed to the first heating zone 20 (horizontal arrow).

Finally, the liquid desiccant reaching the extent of the first heating zone 20, is feed to the LD diversion loop valve 68. As that point the heated liquid desiccant will be directed toward the distributor 29 or the liquid desiccant diversion loop 66.

In some embodiments, the first heating zone 20, the second heating zone 22, and the third heating zone 24 are part of different heat exchangers.

In some embodiments, such as FIGS. 1-6, 8, and 9, the heating loop 18 is a refrigerant loop with refrigerant flowing therein. In such embodiments, the heating loop 18 can include a compressor 48 adapted for converting gaseous refrigerant into a hot refrigerant that is used for the heating zones 20, 22, 24.

In some such embodiments, the heating loop 18 includes an expansion valve 50 where the liquid refrigerant expands into a gas. As will be understood, the expansion process results in a cold gas exiting the expansion valve 50.

In some embodiments, the refrigerant loop 18 includes an evaporator 52 following the expansion valve 50. In some such embodiments, the exhaust stream 38 exiting the heat and mass exchanger 16 contacts the refrigerant in the evaporator 52 prior to being released from the regeneration system 10. In particular, the refrigerant in the refrigerant loop 18 flows within evaporator tubes 70 (e.g., a radiator), while the exhaust stream 38 is cooled as it flows over the evaporator tubes 70. In this way, the evaporator 52 cools the hot exhaust stream 38 prior to the exhaust stream 38 being released from the regeneration system (e.g., to the atmosphere).

In some embodiments, for each of the components that are present, refrigerant in the refrigerant loop 18 can flow through the compressor 48, then the first heating zone 20, then the second heating zone 22, then (if present) the third heating zone 24, then the expansion valve 50, then the evaporator 52, before returning to the compressor 48. It should be noted that additional components can be present in the refrigerant loop 18 and may be positioned between the aforementioned components 48, 20, 22, 24, 50, 52 as appropriate. Additional components that can be included in the refrigerant loop 18 include, but are not limited to, filter drier, accumulator, diverter valves, 3-way valves, sight glass, pressure and temperature sensors, heat exchangers, and Schrader valves.

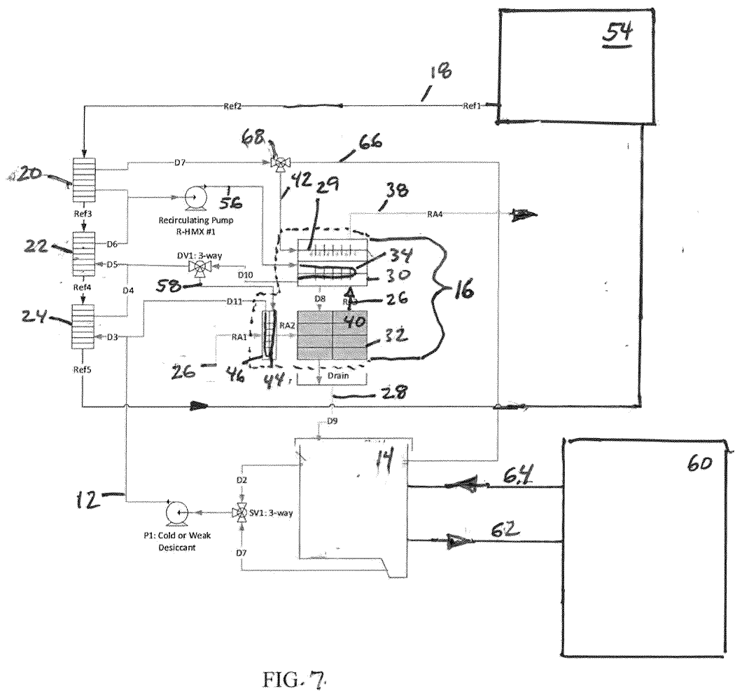

In some embodiments, as shown in FIG. 7, the heating loop 18 includes a unit operation 54 that uses the heating zones 20, 22, 24 as a heat sink. In such embodiments, the heating loop 18 is used to cool the unit operation 54, while heated fluid exiting the unit operation 54 heats the low concentration liquid desiccant in the first, second, and third heating zone 20, 22, 24. In such embodiments, the heating loop 18 can use a refrigerant that does not require a phase change. For example, the refrigerant can be water, propylene glycol, ethylene glycol, or mixtures thereof. In such embodiments, as shown in FIG. 7, the heating loop 18 may not include a compressor, an expansion, and an evaporator. Examples of unit operations 54 useful in such embodiments include, but are not limited to industrial processes, fuel cells, solar cells, condensers of other HVAC systems, such as chillers, etc.

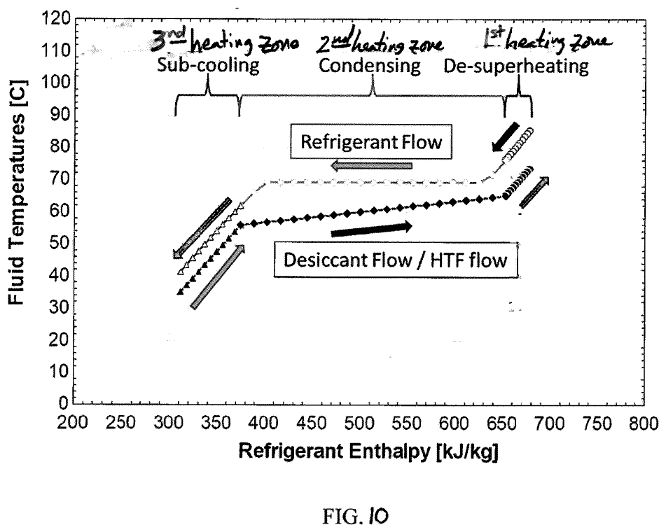

FIG. 10 shows a graph of fluid temperature versus enthalpy for refrigerant in a heating loop 18 that includes first, second, and third heating zones 20, 22, 24, as well as, the low concentration liquid desiccant. The top line going right to left shows the temperature of the refrigerant in the heating loop 18 as it passes through the first, second and third heating zones 20, 22, 24, while the lower line going left to right shows the temperature of the low concentration liquid desiccant as it passes through the thirds, second, and first heating zones 24, 22, 20.

In some embodiments, the refrigerant in the heating loop 18 is de-superheated in the first heating zone 20, then condensed in the second heating zone 22, and is sub-cooled in the third heating zone 24. The largest heat transfer would occur due to the phase change occurring in the condensing regime (middle section), which generally takes place primarily in the second heating zone 22. It will be understood that depending on the size of the heating zones and the initial temperature of the refrigerant and low concentration liquid desiccant, the de-superheat, condensing, and subcooling do not necessarily occur exclusively in one heat exchanger (which may be distinguishable from physical heat exchangers when multiple heat exchangers are used).

In addition to the liquid desiccant regeneration mode described above, the regeneration systems 10 of FIGS. 1-6, 8, and 9, can also be operated in alternative modes. For example, FIG. 8 shows a regeneration system 10 operating in a heating mode, while FIG. 9 shows a regeneration system 10 operated in an evaporator coil anti-frost mode. The components of the regeneration system that are not being used in the alternative operation modes described with FIGS. 8 and 9 are shown in grey. However, the components shown in grey would be used once the regeneration systems 10 are operated in regeneration mode.

As shown in FIG. 8, when the regeneration system 10 is operated in heating mode, there is no flow of liquid desiccant to the heat and mass exchanger 16. All valves and/or pumps that cause liquid desiccant to flow into the heat and mass exchanger 16 are closed or turned off. Thus, liquid desiccant exiting the first heating zone 20 flows through the LD diversion loop 66 back to the liquid desiccant tank 14. In some embodiments of regeneration mode, the LD diversion loop valve 68 is turned so that liquid desiccant does not flow through the LD diversion loop 66 (e.g., the liquid desiccant is fed to the heat and mass exchanger 16). In heating mode, liquid desiccant flowing through the diversion loop 66 returns to the LD tank 14 warmer than it exited the tank at 12. In some embodiments, the heated liquid desiccant 62′ in the liquid desiccant tank 14 is fed as a heating stream to a heater component 72 (e.g., heating fluid for an air conditioner) and is then returned as cooled liquid desiccant 64′. In some embodiments, the heater component 72 can be a conditioner of a dehumidification system 60. In addition, heating mode can be helpful to prevent clogging of pipes when the LD tank 14 is exposed to cold temperatures (e.g., during winter).

Thus, in heating mode operation, the heating loop 18 operates as normal, while the liquid desiccant flow from the liquid desiccant tank 14 through the third (when present), second, and first heating zones 24, 22, 20, then back to the liquid desiccant tank 14.

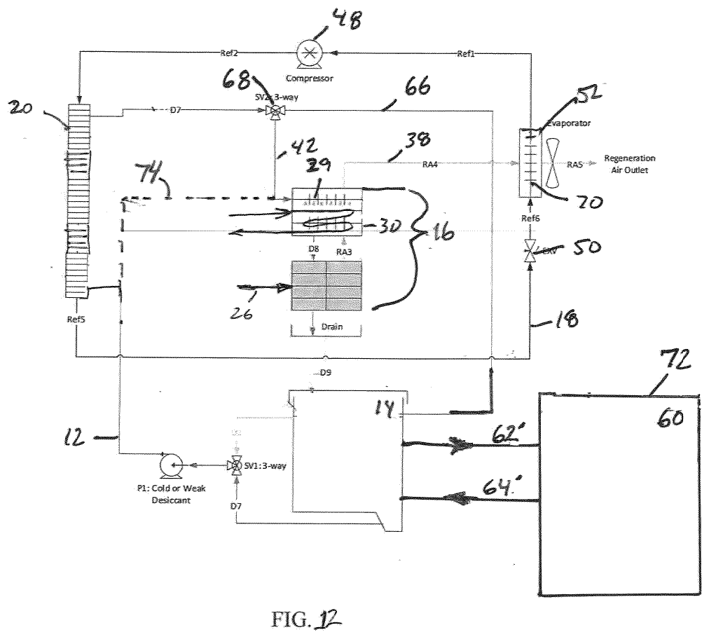

As shown in FIGS. 9 and 12, a regeneration system 10 that includes a liquid desiccant regeneration loop 12 comprising a liquid desiccant tank 14, a heating zone 20, and a heat and mass exchanger 16; and a refrigerant loop 18 comprising the heating zone 20, an expansion valve 50, an evaporator 52, and a compressor 48. A first portion of liquid desiccant in the liquid desiccant tank 14 flows to the heat and mass exchanger 16 before being returned to the liquid desiccant tank 14. In addition, regeneration air 26 is passed through the heat and mass exchanger 16, where the first portion of liquid desiccant flowing in the heat and mass exchanger 16, 30 dehumidifies the regeneration air 26 to form a dehumidified exhaust stream 38, and the dehumidified exhaust stream 38 is fed to the evaporator 52 in order to reduce or eliminate the presence of frost on an evaporator coil 70 of the evaporator.

In some embodiments, a second portion of the liquid desiccant flows to the heating zone 20 and is then returned to the liquid desiccant tank 14 without being fed into the heat and mass exchanger 16, 30. In some embodiments, the second portion of liquid desiccant is larger than the second portion of liquid desiccant.

In some embodiments, the first portion of liquid desiccant passes through at least one heating zone 20, 22, 24 before being fed to the heat and mass exchanger 16 (e.g., the HMX core 30). In other embodiments, the first portion of liquid desiccant flows through the heater diversion loop 74 directly to the heat and mass exchanger 16 (e.g., the HMX core 30). In some embodiments, it may be beneficial for the liquid desiccant to be cool (rather than heated) to facilitate dehumidification of the regeneration air 26 in the heat and mass exchanger 16.

As shown in FIG. 9, the regeneration system 10 can be operated in evaporator coil anti-frost mode, which is a variant of heating mode described above. When operated in evaporator coil anti-frost mode, a reduced amount of liquid desiccant is fed into the HMX core 30 through the distributor 29. In this mode of operation, the liquid desiccant is used to dehumidify the regeneration air stream 26 before it passes through the evaporator 52. Dehumidification may be facilitated where the distributor 29 is a plurality of sprayers or drip tubes. In some embodiments, as shown by the dashed line 74 in FIG. 9, the low concentration liquid desiccant is diverted from one or more of the first, second, or third heating zones 20, 22, 24 so that the liquid desiccant is not hot enough for regeneration when it enters the heat and mass exchanger (HMX) 16 through the distributor 29 and the HMX 16 operates as a dehumidifier (e.g., the exhaust stream 38 is dehumidified air).

Anti-frost mode can also be enhanced by heating the refrigerant flowing through the evaporator coil 70. Thus, in some embodiments, the direction of flow in the heating loop 18 is reversed so that hot refrigerant exits the compressor 48 and flows through the evaporator 52 before passing through the expansion valve. This helps melt any ice that has formed on the evaporator coil 70, while the dehumidified exhaust stream 38 can carry the resulting moisture to the environment. In the embodiments described above, evaporator coil anti-frost mode can be used to prevent ice build-up on the evaporator coil 70 when it is cold outside.

Anti-frost mode can also be implemented using regeneration systems 100 that are simplified compared to the system of FIG. 9. For instance, as shown in FIG. 12, such a regeneration system 100 can include a heat exchanger that includes a first heating zone 20 that is part of a heating loop 18 that includes an expansion valve 50, an evaporator 52, and a compressor 48. The regeneration system 100 can also include a LD regeneration loop 12 comprising a liquid desiccant tank 14, the single heat exchanger 102, and a heat and mass exchanger 16. As will be understood, in anti-frost mode, the LD regeneration loop 12 would be operated to dehumidify the regeneration air stream 26 and produce a dehumidified exhaust stream 38 to that moisture generated while the evaporator coil defrosts can evaporate into the dehumidified exhaust stream 38.

As will be apparent from the foregoing, any of the regeneration systems 10, 100 described herein can be operated in evaporator coil anti-frost mode.

In another aspect, a method of operating a regeneration system is provided. In some embodiments, the regeneration system is a regeneration system 10 according to any embodiment described herein. The method includes heating low concentration liquid desiccant; flowing a first portion of the heated low concentration liquid desiccant through a heat and mass exchanger 16 to produce high concentration liquid desiccant 28; and using a second portion of heated low concentration liquid desiccant to drive moisture from a first portion of the low concentration liquid desiccant within the heat and mass exchanger 16.

In some embodiments, the first portion is at a higher temperature than the second portion. In some embodiments, the heat and mass exchanger 16 converts the low concentration liquid desiccant into high concentration liquid desiccant.

In some embodiments, the second portion of heated low concentration liquid desiccant flows within HMX heat transfer tubes 34 that heat the first portion of the low concentration liquid desiccant within the heat and mass exchanger 16 (e.g., the HMX core 30).

In some embodiments, the second portion of heated low concentration liquid desiccant heats a regeneration air stream 26 that is contacted with the first portion of the low concentration liquid desiccant. For example, in some embodiments, the regeneration air stream 26 can be heated within a regeneration air heater 46 (e.g., within the regeneration air heater 46).

In some embodiments, the regeneration system 10 includes a third portion of heated low concentration liquid desiccant, where the third portion of heated low concentration liquid desiccant heats a regeneration air stream 26 that is contacted with the first portion of the low concentration liquid desiccant. In some such embodiments, the second portion of heated low concentration liquid desiccant flows within HMX heat transfer tubes 34 that heat the first portion of the low concentration liquid desiccant within the heat and mass exchanger 16 (e.g., the HMX core 30).

In some such embodiments, the second portion is at a higher temperature than the third portion.

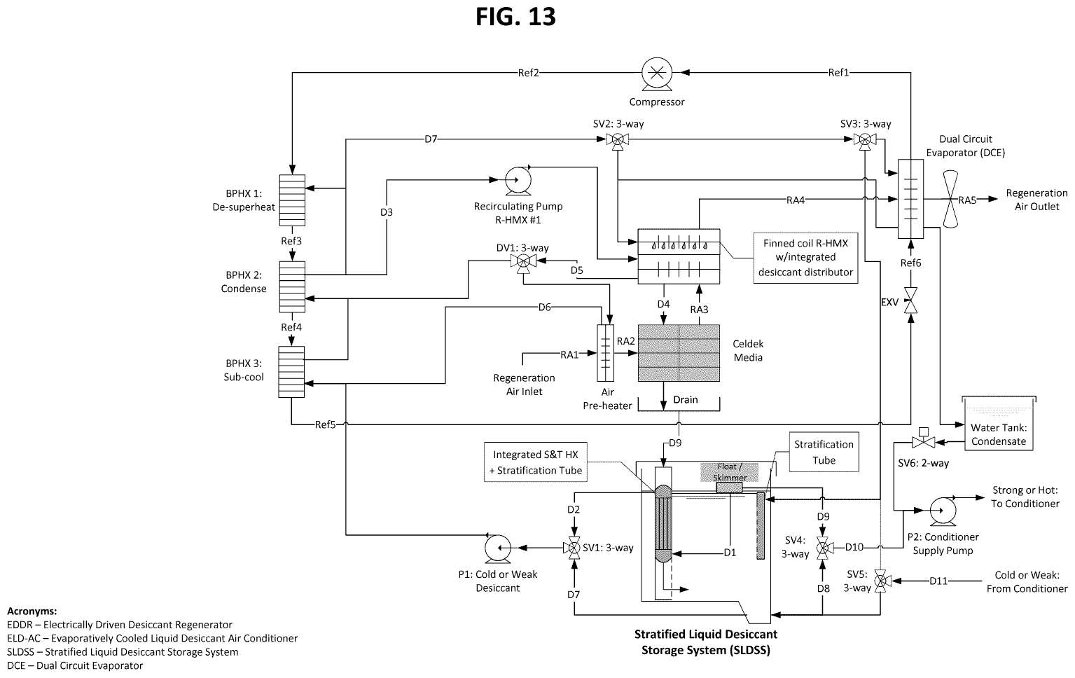

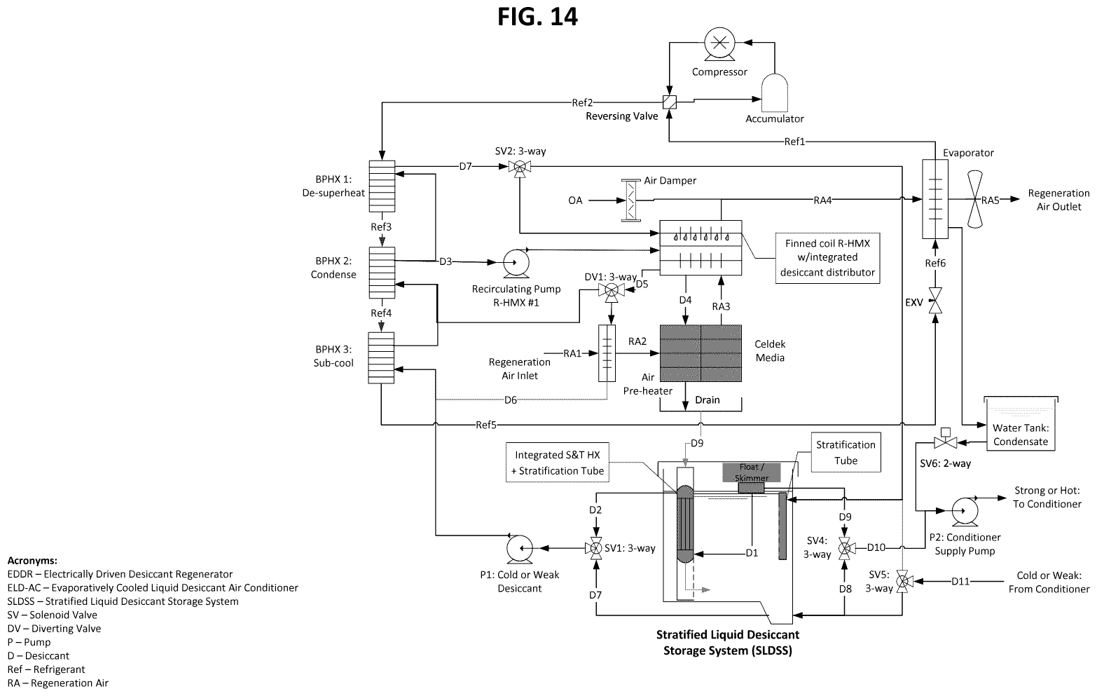

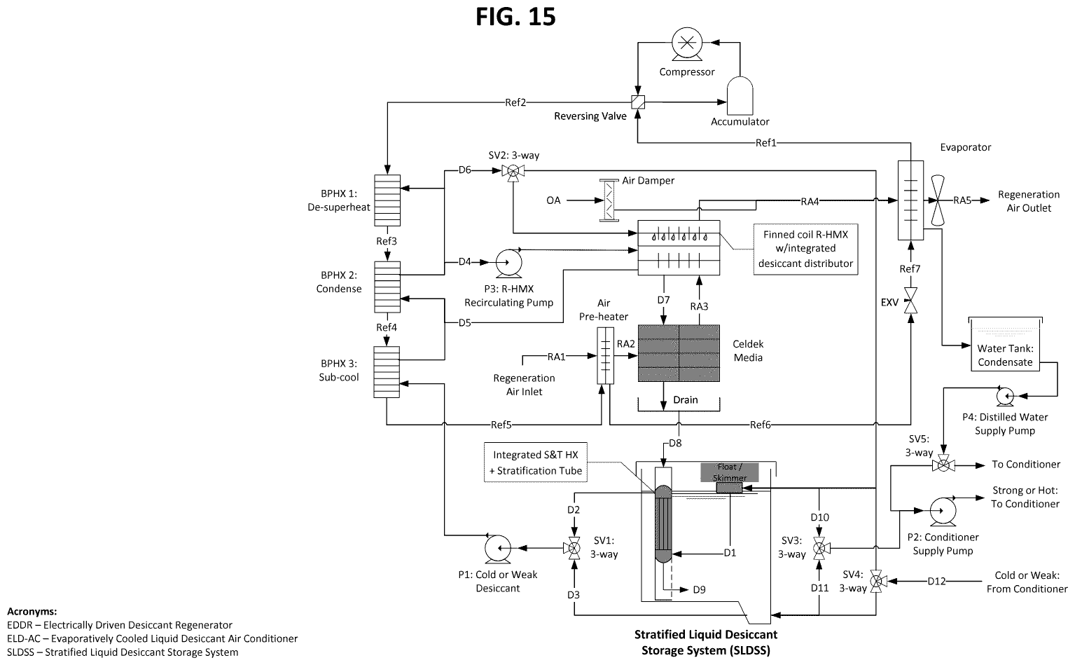

FIG. 13 illustrates a regeneration system 10 using a regeneration heat and mass exchanger, an integrated shell and tube heat exchanger, stratification tube, and cold climate heat pump operation according to some embodiments described herein. FIG. 14 illustrates a regeneration system 10 using a regeneration heat and mass exchanger, an integrated shell and tube heat exchanger, and cold climate heat pump operation according to some embodiments described herein. FIG. 15 illustrates a regeneration system 10 using refrigerant to air subcooling, a regeneration heat and mass exchanger, integrated shell and tube heat exchanger, and cold climate heat pump operation according to some embodiments described herein. In FIGS. 13-15, the first heating zone 20 is used to de-superheat, the second heating zone 22 is used to condense, and the third heating zone 24 is used to sub-cool the refrigerant stream. A stratified liquid desiccant storage system (as shown in FIGS. 13-15) may be used to hold desiccant heated to different temperatures. In some embodiments, the regeneration system 10 may include a stratification tube (as shown in FIGS. 13 and 15). In the embodiments shown in FIGS. 13-15, water condensate may be collected in a tank and used to regenerate the desiccant.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A regeneration system, comprising:
a liquid desiccant regeneration loop comprising a liquid desiccant tank, a second heating zone, a first heating zone, and a heat and mass exchanger; and
a heating loop comprising the first heating zone and the second heating zone, wherein temperatures in the first heating zone are higher than temperatures in the second heating zone,
wherein low concentration liquid desiccant in the liquid desiccant tank flows sequentially from the second heating zone to the first heating zone then through the heat and mass exchanger before being stored as high concentration liquid desiccant, and
wherein a portion of the low concentration liquid desiccant exiting the first heating zone or the second heating zone is used as a heating fluid for the heat and mass exchanger.

2. The regeneration system of claim 1, wherein low concentration liquid desiccant exiting the first heating zone is fed into the heat and mass exchanger and contacted with a regeneration air stream, then exits the heat and mass exchanger as high concentration liquid desiccant.

3. The regeneration system of claim 2, wherein a portion of the low concentration liquid desiccant exiting the first or second heating zone flows within HMX heat transfer tubes in the heat and mass exchanger, and
wherein the HMX heat transfer tubes are adapted to heat low concentration liquid desiccant being regenerated within the heat and mass exchanger.

4. The regeneration system of claim 2, wherein a portion of low concentration liquid desiccant exiting the second heating zone flows within regeneration air heating tubes to heat regeneration air fed to the heat and mass exchanger, and
wherein the heated regeneration air flowing within the heat and mass exchanger contacts low concentration liquid desiccant within the heat and mass exchanger and exits as exhaust air.

5. The regeneration system of claim 4, wherein a portion of the low concentration liquid desiccant exiting the first heating zone flows within HMX heat transfer tubes in the heat and mass exchanger, and
wherein the HMX heat transfer tubes are adapted to heat low concentration liquid desiccant being regenerated within the heat and mass exchanger.

6. The regeneration system of claim 1, wherein the refrigerant loop further comprises an expansion valve and an evaporator, wherein refrigerant exits the second heating zone, then flows through the expansion valve, then the evaporator;
wherein exhaust air exiting the heat and mass exchanger contacts the refrigerant in the evaporator prior to being released from the regeneration system.

7. The regeneration system of claim 6, wherein the refrigerant loop further comprises a compressor, wherein refrigerant flows from the evaporator to the compressor before flowing through the first heating zone.

8. The regeneration system of claim 1, wherein the first heating zone and the second heating zone are part of the same heat exchanger.

9. The regeneration system of claim 1, wherein the first heating zone and the second heating zone are part of different heat exchangers.

10. The regeneration system of claim 1, further comprising a third heating zone;
wherein the liquid desiccant regeneration loop comprises the third heating zone;
wherein the heating loop comprises the third heating zone, wherein temperatures in the first heating zone are higher than temperatures in the second heating zone, and temperatures in the second heating zone are higher than temperatures in the third heating zone,
wherein low concentration liquid desiccant in the liquid desiccant tank flows sequentially from the third heating zone to the second heating zone to the first heating zone then through the heat and mass exchanger before returning to the liquid desiccant tank as high concentration liquid desiccant,
wherein a portion of the low concentration liquid desiccant exiting the second heating zone is used as a first heating fluid for the heat and mass exchanger; and
wherein a portion of the low concentration liquid desiccant exiting the third heating zone is used as a second heating fluid for the heat and mass exchanger.

11. The regeneration system of claim 10, wherein low concentration liquid desiccant exiting the first heating zone is fed into the heat and mass exchanger and contacted with a regeneration air stream, then exits the heat and mass exchanger as high concentration liquid desiccant.

12. The regeneration system of claim 11, wherein the first heating fluid flows within HMX heat transfer tubes in the heat and mass exchanger, and
wherein the HMX heat transfer tubes are adapted to heat low concentration liquid desiccant being regenerated within the heat and mass exchanger.

13. The regeneration system of claim 11, wherein the second heating fluid flows within regeneration air heating tubes to heat regeneration air fed to the heat and mass exchanger, and
wherein the heated regeneration air flowing within the heat and mass exchanger contacts low concentration liquid desiccant within the heat and mass exchanger and exits as exhaust air.

14. The regeneration system of claim 10, wherein the refrigerant loop further comprises an expansion valve and an evaporator, wherein refrigerant exits the third heating zone, then flows through the expansion valve, then the evaporator;
wherein exhaust air exiting the heat and mass exchanger contacts the refrigerant in the evaporator prior to being released from the generation system.

15. The regeneration system of claim 1, wherein the regeneration system is adapted to operate in a heating mode where the low concentration liquid desiccant does not flow through the heat and mass exchanger, further comprising a liquid desiccant diversion loop,
wherein, in heating mode, the low concentration liquid desiccant in the liquid desiccant tank flows sequentially from the second heating zone to the first heating zone then through the liquid desiccant diversion loop before being returned to the liquid desiccant tank.

16. A regeneration system, comprising:
a liquid desiccant regeneration loop comprising a liquid desiccant tank, a heating zone, and a heat and mass exchanger; and
a refrigerant loop comprising the heating zone, an expansion valve, an evaporator, and a compressor;
wherein a first portion of the liquid desiccant in the liquid desiccant tank flows to the heat and mass exchanger before being returned to the liquid desiccant tank,
wherein regeneration air is passed through the heat and mass exchanger, wherein the first portion of liquid desiccant flowing in the heat and mass exchanger dehumidifies the regeneration air to form a dehumidified exhaust stream, and
wherein the dehumidified exhaust stream is fed to the evaporator in order to reduce the presence of frost on an evaporator coil of the evaporator.

17. A method of operating a regeneration system, comprising:
heating low concentration liquid desiccant; and
flowing a first portion of the heated low concentration liquid desiccant through a heat and mass exchanger to produce high concentration liquid desiccant, wherein a second portion of heated low concentration liquid desiccant is used to drive moisture from a first portion of the low concentration liquid desiccant within the heat and mass exchanger.

18. The method of claim 17, wherein the second portion of heated low concentration liquid desiccant flows within HMX heat transfer tubes that heat the first portion of the low concentration liquid desiccant within the heat and mass exchanger.

19. The method of claim 17, wherein the second portion of heated low concentration liquid desiccant heats a regeneration air stream that is contacted with the first portion of the low concentration liquid desiccant.

20. The method of claim 17, further comprising a third portion of heated low concentration liquid desiccant,
wherein the third portion of heated low concentration liquid desiccant heats a regeneration air stream that is contacted with the first portion of the low concentration liquid desiccant.
